(19) United States
(12) Patent Application Publication
(10) Pub. No.: US 2002/0178604 A1
(43) Pub. Date: Dec. 5, 2002

(54) Apparatus for drying solid insulation of an electrical device

(76) Inventors: Paul Gmeiner, Oberwil-Lieli (CH); Peter Keller, Zurich (CH)

Correspondence Address: Robert S. Swecker, BURNS, DOANE, SWECKER & MATHIS, L.L.P., P.O. Box 1404, Alexandria, VA, 22313-1404, US

(21) Appl. No.: 10/106,237

(22) Filed: Mar. 27, 2002

(30) Foreign Application Priority Data
Apr. 6, 2001 (EP) 01810344.0

(51) Int. Cl. F26B 21/06

(52) U.S. Cl. 34/77; 34/73; 34/72

(57) ABSTRACT

The apparatus serves for drying solid insulation of an electrical device (40) by means of the heat of condensation emitted by the vapor of a solvent. It has an evacuable autoclave (10) accommodating the solid insulation, as well as an evaporator (20) producing solvent vapor, an evacuable condenser (50), connected to the autoclave (10), for condensing a solvent led out of the autoclave (10) and a vapor mixture containing water, and a heat recuperator (30). In the heat recuperator (30), the solvent acts as heat-absorbing medium and the vapor mixture as heat-emitting medium.

In order to keep the energy requirement of this apparatus low, a heat recuperator (30) exposed to the heat-emitting action of the vapor mixture is arranged in the autoclave (10). Solvent led to the evaporator (20) can thus absorb heat from the drying process in a particularly effective fashion. At the same time, by reducing the heat of the vapor mixture led out of the autoclave (10), only low requirements are made of the condenser (50) and a connecting conduit (51) between the autoclave (10) and the condenser (50). The drying apparatus can therefore simultaneously also be produced cost-effectively.

### TECHNICAL FIELD

The invention proceeds from an apparatus for drying the solid insulation of an electrical device as claimed in the preamble of patent claim 1.

During operation of this apparatus, the heat of condensation of a solvent vapor produced in an evaporator is utilized so as to heat up, quickly and without damaging it, the solid insulation of the electrical device located in an autoclave kept at underpressure. Water emerging from the solid insulation as the latter is being heated up is led in a solvent/water/vapor mixture to a condensing and separating device in which the vapor mixture is condensed, and water is eliminated from the solvent/water condensate thereby formed.

Insulating oil possibly present in the solid insulation is dissolved out of the solid insulation by the condensed solvent. The solvent/insulating oil solution thereby formed is collected on the floor of the autoclave. The solvent is removed from this solution by subsequent distillation, and the remaining insulating oil is removed from the apparatus.

### PRIOR ART

An apparatus of the type mentioned at the beginning is described by P. K. Gmeiner in the brochure produced by Micafil Vakuumtechnik AG, Zurich, MTV/E 02923000/22 “Modern vapor drying processes and plants”, particularly page 11, diagram S4. This apparatus has a heat recuperator in which a solvent/water/vapor mixture formed as solid insulation is being heated up emits heat, specifically to solvent which is led to an evaporator of the system. The heat absorbed by the solvent considerably reduces the energy requirement of the evaporator. Only a comparatively small quantity of cooling water is required for condensing the precooled vapor mixture in a condenser of the system. This apparatus therefore has good efficiency in terms of energy.

### BRIEF DESCRIPTION OF THE INVENTION

The invention as it is specified in the patent claims is based on the object of reducing the energy requirement of the apparatus named at the beginning with the aid of simple means.

In the apparatus according to the invention, a first stage of a heat recuperator which is exposed to the heat-emitting action of the vapor mixture is arranged in the autoclave. As the solid insulation is being heated up, solvent led through this stage of the heat recuperator to the evaporator can now be preheated particularly effectively, since the solvent/vapor mixture is not led out of the autoclave to the solvent until after the emission of heat. This measure reduces the energy requirement of the apparatus very substantially.

It is particularly advantageous in terms of energy to feed the first stage of the heat recuperator solvent which has been eliminated from the solvent/water condensate occurring in the drying process, since then the efficiency of the heat recuperator is particularly high, owing to the relatively high temperature differences between solvent and vapor mixture.

Since the temperature of the solvent/water/vapor mixture is substantially reduced in the heat recuperator, and the vapor mixture is partially condensed, the connecting conduit for the vapor mixture that is provided between the autoclave and a condenser producing the solvent/water condensate can be designed in a particularly cost-effective fashion. Since the temperature and the quantity of the vapor mixture have already been substantially reduced in the autoclave, the connecting conduit and the condenser can be given small dimensions. The condenser can then even be attached directly to the autoclave without additional mounting means. In addition, a return conduit and valves for condensate possibly formed from the vapor mixture in the heat recuperator are eliminated, since such a condensate can flow off out of the heat recuperator directly into the autoclave. Because of the low temperature of the vapor mixture emerging from the autoclave, the condenser correspondingly also requires only a small quantity of cooling water.

It is recommended to arrange the evaporator in the autoclave. Firstly, it is then possible for the solvent preheated in the heat recuperator to be led to the evaporator in a simple conduit and without the use of valves. Secondly, there is no need for any vacuum-tight conduit or any vacuum-tight autoclave wall bushing for this conduit.

In a structurally simple embodiment of the apparatus according to the invention, the solvent separated from the condensed vapor mixture is led in a pipeline through the autoclave wall into the interior of the autoclave, and the heat recuperator additionally has a guide element for leading the vapor mixture to a section of this pipeline located in the autoclave.

A flow action that is advantageous for high efficiency of the heat recuperator, and thus also of the apparatus according to the invention, is achieved when the guide element is designed as a wall, and this wall and the part of the autoclave wall through which the pipeline is led have wall sections running mainly parallel to one another and extending predominantly vertically. It is favorable in this case for reasons of flow to lead the guide element from the floor to the ceiling of the autoclave, and to provide at least one opening provided in the region of the floor or the ceiling, for the entry of the vapor mixture into the interior of the heat recuperator. The opening should preferably be of slit-shaped design and extend along a wall of the autoclave. The vapor mixture then has a homogeneous flow behavior over the entire width or length of the autoclave. In addition, a particularly large amount of heat is then exchanged in the heat recuperator.

The apparatus according to the invention is distinguished by a particularly low energy requirement when a second stage, which is exposed to the heat-emitting action of the vapor mixture, of the heat recuperator is arranged in the autoclave, to which stage it is possible to feed as heat-absorbing medium a solvent condensate occurring during drying of the solid insulation and possibly containing oil. For reasons of a simple refinement of the system, this condensate should be fed the solvent preheated in the first stage. In an embodiment which is easy to implement in terms of production engineering, the condensate is led in a pipeline through the autoclave wall into the interior of the autoclave, and the heat recuperator has a guide element which guides the vapor mixture to a heat exchanging path of the heat recuperator in which the condensate led into the autoclave interior acts as heat-absorbing medium.

Process energy can be saved in addition if the drying apparatus additionally has means for indirectly controlling the vapor mixture led out of the autoclave. It is then possible to eliminate a comparatively expensive control valve between the autoclave and the condenser.

A particularly precise indirect control is achieved in this case when the means comprise devices for measuring the quantities of water and solvent occurring per time unit in the condensed vapor mixture, as well as devices for forming a solvent desired value curve from the measured values of the water quantity occurring per time unit and an empirically predetermined weighting factor, and for forming a control signal for an element for controlling the throughput of the vapor mixture emerging from the autoclave.

A control that is satisfactory for many applications is possible when the means comprise devices for measuring the quantity of solvent occurring per time unit and the partial pressure of the water vapor in the autoclave, as well as devices for forming a solvent desired value curve from the measured values of the partial pressure of the water vapor and the empirically predetermined weighting factor, and for forming a control signal for an element for controlling the throughput of the vapor mixture emerging from the autoclave.

Control valves arranged in a conduit connecting the condenser to a vacuum unit and conducting inert gas and/or arranged in a cooling water return of the condenser, and/or an inlet valve for inert gas that can be fed from outside have proved themselves as control elements.

### BRIEF DESCRIPTION OF THE DRAWINGS

An exemplary embodiment of the invention is illustrated in a simplified way in the drawings, in which:

FIG. 1 shows a sketch of the principle of an embodiment of the drying apparatus according to the invention, having an autoclave which accommodates solid insulation to be dried and from which a solvent/water/vapor mixture is guided out as the solid insulation is being heated up, and

FIG. 2 shows a diagram in which the profile of some parameters typical of the operation of the apparatus according to FIG. 1 is illustrated as a function of time.

### WAYS OF IMPLEMENTING THE INVENTION

In the drying apparatus illustrated in the figure, 10 denotes a heatable and evacuable autoclave in which an evaporator 20 for a solvent and a heat recuperator 30 are arranged. Also located in the autoclave 10 is an object to be dried, for example an electrical device 40 having hygroscopic solid insulation, for example a transformer. The heat recuperator is connected to a condenser 50 via a pipeline 51. It can be connected via a pipeline 81 to a solvent transfer pump 80 discharging solvent from a separating vessel 70.

The heat recuperator 30 is aligned vertically and has a boundary wall 31 which extends mainly parallel to an autoclave side wall 11 and acts as guide element. Together with the autoclave side wall 11, this wall bounds a space 32 which is designed like a shaft and is connected to the interior of the autoclave, which contains the evaporator 20, via an opening 33 located in the region of the autoclave floor 1. The opening 33 is of slit-shaped design and extends mainly horizontally over the depth of the autoclave 10, which is determined by the side wall 11. At its upper end, the space 32 opens into the pipeline 51, which is led to the outside in a vacuum-tight fashion through the autoclave side wall 11. The space 32 is subdivided into two partial spaces which are arranged vertically one above another and in each case contain a heat exchanging path 34 or 35, respectively, for a heat-absorbing medium. The partial space containing the path 34 is assigned to a first stage 36, and the partial space containing the path 35 is assigned to a second stage 37 of the heat recuperator. The lower end of the path 34 or 35, respectively, cooperates with the pipeline 81, led in a vacuum-tight fashion through the wall 11, or a pipeline 12, likewise led in a vacuum-tight fashion through the wall 11, whereas the upper end of the path 34 opens into the end, led into the space 32, of the pipeline 12, and the upper end of the path 35 opens into a pipeline 21 leading to the evaporator 20. The paths 34 and 35 can be designed, for example, as pipe sections. As is indicated by dashes, the pipeline 21 can be led, if appropriate, to an external evaporator 22 in a vacuum-tight fashion through the autoclave wall. This external evaporator can be connected to the autoclave 10 via a valve 23.

The condenser 50 is connected to the separating vessel 70 via a flowmeter 54. The condenser 50 can be connected, furthermore, to a vacuum unit 60 via a valve 53. The condenser 50 can be connected, furthermore, to the vacuum unit 60 via an inert gas control valve 61. An inlet valve 62, which is connected to an inert gas source such as, in particular, air or nitrogen, is located in this connection between an outlet of the condenser 50—or an outlet of the connection between the condenser 50 and separating vessel 70—and the control valve 61. A cooling water control valve 52 is arranged in a cooling water feed of the condenser 50.

The output signals of the flowmeter 54 and of a level sensor 71 provided at the separating vessel 70 are fed to a control and regulator device 90. The control and regulator device processes these signals and forms control signals for the valves 52, 61 and 62.

Provided in the separating vessel 70 is an outlet which can be connected via the transfer pump 80 to a solvent storage vessel 82 or, optionally, to the pipeline 81. The connection to the solvent storage vessel 82 can be produced via a valve 83, and that to the pipeline 81 via a valve 84. Connected downstream of the pump 80 is a flowmeter 85 whose measurement signals are fed to the control and regulator device 90.

Provided in the floor of the autoclave 10 is an outflow which either can be connected to the pipeline 12 via a transfer pump 86 and a valve 87, or can be connected via the transfer pump 86 and a valve 88 to a storage container for insulating oil which is washed out of the solid insulation during condensation of the solvent.

Also fitted at the autoclave is a pressure meter 13 which can determine the partial pressure of the water vapor located in the autoclave, and relays corresponding signals to the control and regulator device. 55 denotes a temperature sensor which detects the temperature of the cooling water discharged from the condenser 50.

The mode of operation of this apparatus is as follows: the autoclave 10 loaded with the solid insulation is firstly evacuated using the vacuum unit 60 in order to dry the solid insulation of the electrical device 40. With the valve 53 closed, the evaporator 12 and/or the evaporator 22 generates solvent vapor which condenses on the solid insulation and thereby heats the latter up. At the same time, the condensed solvent dissolves insulating oil possibly present in the solid insulation, or other contaminants. The solvent condensate, possibly containing oil, collects on the floor of the evacuated autoclave and is pumped into the heat exchanging path 35 by the transfer pump 86 with the valve 88 closed via the open valve 87 and the pipeline 12. Heating up the solid insulation 40 causes water vapor and inert gases, possibly present in the solid insulation, to enter the autoclave and form with the solvent vapor a solvent/water/vapor mixture in which the possibly present inert gases are also contained. This vapor mixture passes through the opening 33 into the space 32 containing the heat exchanging paths 34 and 35 of the heat recuperator 30, and is led upward there via the heat exchanging paths and, finally sucked via the pipeline 51 into the condenser 50 in which it is separated as solvent/water condensate. The inert gases possibly also exhausted are led into the vacuum unit 60 via the condenser 50 and the control valve 61. Since the opening 33 extends over the entire depth of the autoclave 10 into the interior thereof, the vapor mixture enters the heat recuperator 30 in a fashion which is not punctiform but linear. This permits a homogeneous, large-area flow, and thereby a very good exchange of heat.

Solvent and water are subsequently obtained from the condensate in the separating vessel 70. With the valve 83 closed, the solvent thus obtained is conveyed via the solvent transfer pump 80, the open valve 84 and the pipeline 81 into the heat exchanging path 34 which is provided in the first stage 36 of the heat recuperator 30 and in which it absorbs heat from the solvent/water vapor mixture acting as heat-emitting medium. The solvent preheated in such a way is fed via the second stage 37 of the heat recuperator, or else directly, to the evaporator 20. Because the heat recuperator 30 is arranged in the autoclave, a particularly small quantity of process heat is lost, and the condenser 50 can correspondingly have small dimensions. At the same time, the evaporator 20 must be fed virtually only the energy required to heat up the solid insulation.

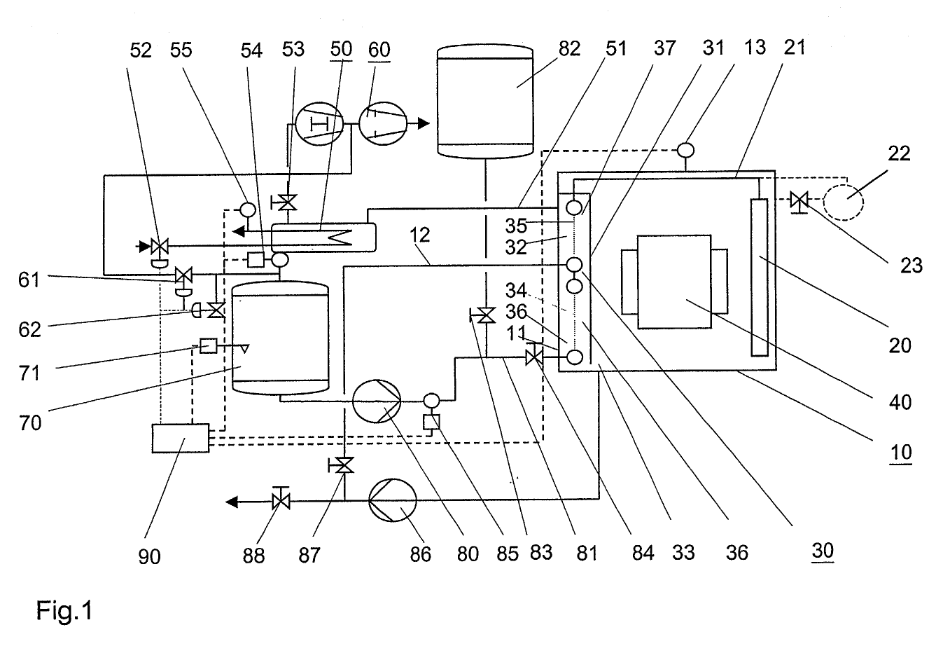

The efficiency of the drying process is particularly high when the condensate collecting on the floor of the autoclave 10 is conveyed, with closed valve 88, into the second stage 37 of the heat recuperator by means of the transfer pump 86 via the open valve 87 and the pipeline 12, and absorbs heat from the vapor mixture in the heat exchanging path 35. If, as illustrated in FIG. 1, this condensate is brought into the second stage 37 together with the solvent preheated in the first stage 36, a particularly large amount of process heat can be obtained from the vapor mixture. The condensate heated in the second stage 37 and/or the additionally heated solvent fed from the first stage is/are fed to the evaporator 20 and/or the evaporator 22 where it/they evaporate(s) with low energy consumption.

It is greatly advantageous in this case that installation of the heat recuperator in the autoclave 10 eliminates return conduits and valves for solvent formed in the heat recuperator 30 by condensation of solvent/water/vapor mixture, since the solvent condensed in the heat recuperator 30 flows off directly into the autoclave 10. Since the evaporator 20 and the heat recuperator 30 are situated in the autoclave, the solvent feed conduit 21 can be of simple design, that is to say, in particular, have no valves and no vacuum bushings. Moreover, there is no need for the heat recuperator 30 to be designed either in a vacuum-tight or thermally insulated fashion. For the reasons mentioned above, the heat recuperator 30 can be of simple design and can be installed at points in the autoclave which are easy to access. It can then be cleaned easily.

During the heating-up phase of the drying method, process energy can additionally be spared when the return rate of the vapor mixture guided out of the autoclave 10 is controlled as follows:

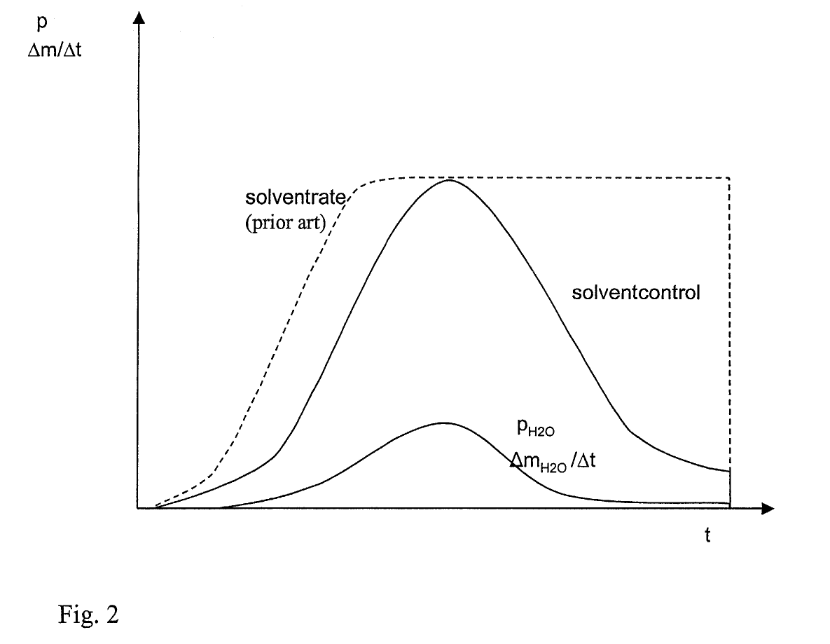

the level sensor 71, or a flowmeter (not illustrated) determining the outflow of water from the separating vessel is used to determine, for example in kg, the quantity Δm_{H20} of water occurring per time unit At, for example every 10 minutes, in the drying process. A signal proportional to this temporal change in quantity Δm_{H20}/Δt is fed to the control and regulator device 90. The time characteristic of this signal during the heating-up phase, that is to say the quantity of water removed continuously from the autoclave per time unit in this period, is illustrated in FIG. 2.

This signal is weighted in the control and regulator device 90 with the aid of a predetermined weighting factor which describes the units of quantity of solvent required to remove one unit of quantity of water from the solid insulation 40. The weighting factor is a function, inter alia, of the quantity of solid insulation and the physical properties of the solvent and can be determined empirically, for example by test dryings. The weighting factor is typically between 4 and 10 during the heating-up phase. The result is thus a solvent desired value curve solventcontrol illustrated in FIG. 2. This solvent desired value curve indicates the desired value of the returning quantity of solvent per time unit during the heating-up phase.

As an alternative, or in addition, this solvent desired value curve can also be determined by measuring the partial pressure p_{H20}, prevailing in the autoclave 10, of the water vapor with the aid of the pressure meter 13. A signal proportional to the water vapor partial pressure p_{H20} is likewise weighted with the predetermined weighting factor in the control and regulator device. The result is thus likewise the solvent desired value curve solventcontrol illustrated in FIG. 2.

The flowmeter 85 is used to measure the returning quantity of solvent directly, or else to determine it indirectly by measuring the flow rate of the condensate, led into the separating vessel 70, with the aid of the flowmeter 61. The measured or indirectly determined actual value is compared with the corresponding desired value yielded from the solvent desired value curve. If the actual value deviates too much from the desired value, the control and regulator device 90 outputs a command to a regulator element which regulates the quantity of the vapor mixture led out of the autoclave 10 into the condenser 50 in such a way that the returning solvent quantity is adapted to the solvent desired value curve. The quantity of the vapor mixture emerging from the autoclave 10 has so far been regulated such that the quantity of condensate occurring in the condenser 40 per time unit was kept constant after traversal of an initial phase. The corresponding temporal characteristic of the solvent occurring is drawn in with dashes in FIG. 2 (solvent return curve solventrate prior art).

The surfaces under the solvent desired value curve solventcontrol and the solvent return curve solventrate, illustrated by dashes, according to the prior art are a measure of the energy destroyed in the condenser 50 in the case of the method according to the invention and in the case of the method according to the prior art. The quantity of energy defined by the difference between the areas of the two curves is saved in the method according to the invention.

The inert gas control valve 61 included in the connecting conduit from the condenser 50 to the vacuum unit 60 is preferably provided to control the solvent return. By varying the inert gas pressure, this control valve determines the occurrence of condensate in the condenser 50, and thus the quantity of solvent returning per time unit. An otherwise customary control valve can thus be eliminated in the pipeline 51 between the autoclave 10 and condenser 50. If too little inert gas occurs in the autoclave 10 or owing to leakage losses, some inert gas can additionally be let into the condenser 50 via the inlet valve 62 and the occurrence of condensate can thus be throttled.

A further advantageous, indirect control of the solvent return is achieved by controlling the cooling water of the condenser 50. For this purpose, the temperature of the cooling water is measured using the temperature sensor 55 in the cooling water return, the measured temperature is monitored by the control and regulator device 90, and upon overshooting of a limiting value a control command is output to the cooling water control valve 61 with the aid of which the advance of the cooling water is varied. This controls the occurrence of condensate in the condenser 50 and also, thus, the quantity of solvent returning per time unit. A vapor control valve between the autoclave and condenser is also dispensable in the case of this control. A particularly high level of redundancy of the method is achieved by combining the cooling water control with the inert gas control.

List of reference symbols

| | |
|---|---|
| 10 | Autoclave |
| 11 | Autoclave wall |
| 12 | Pipeline |
| 13 | Partial pressure meter |
| 20 | Evaporator |
| 21 | Pipeline |
| 22 | Evaporator |
| 23 | Valve |
| 30 | Heat recuperator |
| 31 | Boundary wall |
| 32 | Space |
| 33 | Opening |
| 34, 35 | Heat exchanging paths |
| 36, 37 | Stages |
| 40 | Electrical device with solid insulation |
| 50 | Condenser |
| 51 | Pipeline |
| 52 | Cooling water control valve |
| 53 | Valve |
| 54 | Flowmeter |
| 55 | Temperature sensor |
| 60 | Vacuum unit |
| 61 | Control valve |
| 62 | Inert gas inlet valve |
| 70 | Separating vessel |
| 71 | Level sensor |
| 80 | Solvent pump |
| 81 | Pipeline |
| 82 | Solvent storage vessel |
| 83, 84 | Valves |
| 85 | Flowmeter |
| 86 | Transfer pump |
| 87, 88 | Valves |
| 90 | Control and regulator device |
| Δm_{H2O}/Δt | Quantity of water occurring per time unit |
| p_{H2O} | Water vapor partial pressure in the autoclave |

1. An apparatus for drying solid insulation of an electrical device (40) by means of the heat of condensation emitted by the vapor of a solvent, having
an evacuable autoclave (10) accommodating the solid insulation,
an evaporator (20, 22) producing solvent vapor,
an evacuable condenser (50), connected to the autoclave, for condensing a solvent led out of the autoclave and a vapor mixture containing water, and
a heat recuperator (30) in which solvent fed to the evaporator (20, 22) acts as heat-absorbing medium, and vapor mixture acts as heat-emitting medium,
characterized in that a first stage (36) of the heat recuperator which is exposed to the heat-emitting action of the vapor mixture is arranged in the autoclave (10).

2. The apparatus as claimed in claim 1, characterized in that the evaporator (20) is arranged in the autoclave (10).

3. The apparatus as claimed in one of claim 1 or 2, characterized in that solvent separated from the condensed vapor mixture can be led in a first pipeline (81) through the autoclave wall (11) into the interior of the autoclave (10), and in that the heat recuperator (30) has at least one guide element (31) for leading the vapor mixture to a heat-exchanging path (34), located in the autoclave, of the first stage (36).

4. The apparatus as claimed in claim 3, characterized in that the guide element (31) and the part of the autoclave wall (11) through which the first pipeline (81) is led have wall sections running mainly parallel to one another and extending predominantly vertically.

5. The apparatus as claimed in claim 4, characterized in that the guide element (31) is led from the floor to the ceiling of the autoclave (10) and has at least one opening (33) provided in the region of the floor or the ceiling, for the entry of the vapor mixture into the interior of the heat recuperator (30).

6. The apparatus as claimed in claim 5, characterized in that the opening (33) is of slit-shaped design and extends over a wall (11) of the autoclave.

7. The apparatus as claimed in one of claims 1 to 6, characterized in that a second stage (37), which is exposed to the heat-emitting action of the vapor mixture, of the heat recuperator (30) is arranged in the autoclave (10), and in that the second stage (37) can be fed as heat-absorbing medium a solvent condensate occurring during drying of the solid insulation and possibly containing oil.

8. The apparatus as claimed in claim 7, characterized in that the second stage (37) can additionally be led the solvent preheated in the first stage (36).

9. The apparatus as claimed in one of claim 7 or 8, characterized in that the solvent condensate can be led in a second pipeline (12) through the autoclave wall (11) into the interior of the autoclave (10), and in that the heat recuperator (30) has at least one guide element (31) for leading the vapor mixture to a heat exchanging path (35), located in the autoclave, of the second stage.

10. The apparatus as claimed in one of claims 1 to 9, characterized in that means (13, 54, 71) are additionally provided for indirectly controlling the vapor mixture led out of the autoclave (10).

11. The apparatus as claimed in claim 10, characterized in that the means comprise devices (54, 71) for measuring the quantities of water (Δm_{H20}/Δt) and solvent occurring per time unit in the condensed vapor mixture, as well as devices (90) for forming a solvent desired value curve (solventcontrol) from the measured values of the water quantity occurring per time unit and an empirically predetermined weighting factor, and for forming a control signal for an element (52, 61, 62) for controlling the throughput of the vapor mixture emerging from the autoclave.

12. The apparatus as claimed in claim 10 or 11, characterized in that the means comprise devices (13, 54) for measuring the quantity of solvent occurring per time unit and the partial pressure of the water vapor (p_{H20}) in the autoclave (10), as well as devices (90) for forming a solvent desired value curve(solventcontrol) from the measured values of the partial pressure of the water vapor and an empirically predetermined weighting factor, and for forming a control signal for an element (52, 61, 62) for controlling the throughput of the vapor mixture emerging from the autoclave.

13. The apparatus as claimed in one of claim 11 or 12, characterized in that the control element is designed as a control valve (52, 61, 62) and is arranged in a conduit connecting the condenser (50) to a vacuum unit (60) and conducting inert gas, and/or is arranged in a cooling water return of the condenser (50), and/or has an inlet valve (62) for inert gas that can be fed from outside.
